(19) United States
(12) Patent Application Publication
(10) Pub. No.: US 2017/0199839 A1
(43) Pub. Date: Jul. 13, 2017

(54) BUS OWNERSHIP HAND-OFF TECHNIQUES

(71) Applicant: QUALCOMM Incorporated, San Diego, CA (US)

(72) Inventors: Lalan Jee Mishra, San Diego, CA (US); Richard Dominic Wietfeldt, San Diego, CA (US)

(21) Appl. No.: 14/994,226

(22) Filed: Jan. 13, 2016

(51) Int. Cl. G06F 13/42; G06F 11/30; G06F 13/364

(52) U.S. Cl. CPC G06F 13/4291; G06F 13/364; G06F 11/3027

(57) ABSTRACT

Bus ownership hand-off techniques are disclosed. In one aspect, bus ownership hand-off is handled by providing a mod-N counter in each master associated with the bus. A single clock source is used to increment each mod-N counter synchronously. Each master also includes a trigger table with N entries, corresponding to the N of the mod-N counter. A master host populates entries in each trigger table according to respective priorities of the masters. A comparator in each master is used to compare entries in the trigger table to the mod-N counter. If there is a match between a populated entry and the mod-N counter, transmission by the master is enabled. If there is not a match, transmission for that master is precluded. By enabling hand-off without negotiation, latency associated with hand-off is reduced to approximately two clock cycles, allowing the device to meet stringent timing requirements for various cellular protocols.

### BACKGROUND

I. Field of the Disclosure

The technology of the disclosure relates generally to techniques for performing communication bus ownership hand-off between two or more masters.

II. Background

Computing devices have become increasingly common in modern society. Amongst the more common computing devices are mobile phones. While such devices may initially have started out as simple devices that allowed audio communication through the Public Land Mobile Network (PLMN) to the Public Standard Telephone Network (PSTN), they have evolved into smart phones capable of supporting full multimedia experiences as well as supporting multiple wireless protocols. Even within the cellular wireless protocols, mobile phone radios have developed into highly complex, multi-band, and multi-standard designs that often have multiple radio frequency (RF) signal chains. Every component in the RF signal chain has to be in the desired configuration at any given time, or the system will fail. Therefore, accurate timing, triggers and speed are all necessary.

As further explained in the MIPI Alliance website, “[t]he MIPI Alliance Specification for RF Front-End Control Interface (RFFE) was developed to offer a common and widespread method for controlling RF front-end devices. There are a variety of front-end devices, including Power Amplifiers (PA), Low-Noise Amplifiers (LNA), filters, switches, power management modules, antenna tuners and sensors. These functions may be located either in separate devices or integrated into a single device, depending on the application. The trend in mobile radio communications is towards complex multi-radio systems comprised of several parallel transceivers. This implies a leap in complexity of the RF front-end design. Thus, the RFFE bus must be able to operate efficiently in configurations from the simplest one Master and one Slave configuration to, potentially, multi-Master configurations with tens of Slaves.”

In devices where there are multiple masters on an RFFE bus, the RFFE protocol allows ownership transfer that introduces unavoidable latency. Aggravating the latency issue is that the latency may not be a fixed latency because of collision unpredictability. Such unpredictable latency may interfere with the performance requirements set forth by the various wireless protocols being served by the RF front-end. Accordingly, there is a need for a reduced latency hand-off approach.

### SUMMARY OF THE DISCLOSURE

Aspects disclosed in the detailed description include bus ownership hand-off techniques. In particular, bus ownership hand-off is handled by providing a mod-N counter in each master associated with the bus. A single clock source is used to increment each mod-N counter synchronously. Each master also includes a trigger table with N entries, corresponding to the N of the mod-N counter. A master host populates entries in each trigger table according to respective priorities of the masters. A comparator in each master is used to compare entries in the trigger table to the mod-N counter. If there is a match between a populated entry and the mod-N counter, transmission by the master is enabled. If there is not a match, transmission for that master is precluded. By enabling hand-off without negotiation, latency associated with hand-off is reduced to approximately two clock cycles, allowing the device to meet stringent timing requirements for various cellular protocols.

In this regard in one aspect, a method for controlling a bus shared by plural masters is disclosed. The method includes incrementing a mod-N counter at a first master of a plurality of master devices, the incrementing based on a clock signal. The method also includes comparing an output of the mod-N counter to a trigger table. The method also includes enabling transmission by the first master on an associated bus if the output of the mod-N counter matches an entry in the trigger table.

In another aspect, a method for controlling a bus shared by plural masters is disclosed. The method includes determining a priority technique for sharing a bus by a plurality of masters. The method also includes populating trigger tables in each of the plurality of masters with entries corresponding to the priority technique. The method also includes maintaining a master clock signal on the bus. The method also includes, at each master of the plurality of masters, incrementing a mod-N counter based on the master clock signal. The method also includes, at each master of the plurality of masters, comparing an output of the mod-N counter to the entries in a respective one of the trigger tables. The method also includes enabling transmission on the bus by different ones of the plurality of masters based on whether the output of a respective mod-N counter matches an entry in the respective one of the trigger tables.

In another aspect, a master is disclosed. The master includes a bus interface configured to receive a clock signal from a bus. The master also includes a mod-N counter configured to increment based on the clock signal. The master also includes a trigger table configured to store enable values. The master also includes a comparator coupled to the mod-N counter and the trigger table. The comparator is configured to compare an output of the mod-N counter to the enable values in the trigger table and output a transmit enable signal based thereon. The master also includes a transmitter. The transmitter is configured to transmit data on the bus when the transmit enable signal is present.

In another aspect, a system is disclosed. The system includes a bus. The system also includes a clock source. The system also includes a master host. The master host includes a control system and a bus interface. The bus interface is coupled to the bus. The system also includes a plurality of masters. Each of the plurality of masters includes the bus interface. The bus interface is configured to receive a clock signal from the clock source. Each of the plurality of masters also includes a mod-N counter. The mod-N counter is configured to increment based on the clock signal. Each of the plurality of masters also includes a trigger table. The trigger table is configured to store enable values based on input from the master host. Each of the plurality of masters also includes a comparator coupled to the mod-N counter and the trigger table. The comparator is configured to compare an output of the mod-N counter to the enable values in the trigger table and output a transmit enable signal based thereon. Each of the plurality of masters also includes a transmitter. The transmitter is configured to transmit data on the bus when the transmit enable signal is present.

### BRIEF DESCRIPTION OF THE FIGURES

FIG. 1 is a block diagram of an exemplary system diagram for a mobile terminal showing a radio frequency front-end control interface (RFFE) bus;

FIG. 2 is a block diagram of an RFFE system having multiple masters according to an exemplary aspect of the present disclosure;

FIG. 3A is a flowchart of a process for operating the RFFE system of FIG. 2 according to an exemplary aspect of the present disclosure from a system-level perspective;

FIG. 3B is a flowchart of a process for operating the RFFE system of FIG. 2 according to an exemplary aspect of the present disclosure from a master-level perspective;

FIG. 4 is an illustration of a plurality of trigger tables populated according to an exemplary aspect of the present disclosure;

FIG. 5 is an illustration of an exemplary equal priority technique for a four-bus master RFFE system;

FIG. 6 is an illustration of an exemplary unequal priority technique for a three-bus master RFFE system;

FIG. 7 is an illustration of several exemplary fractional priority techniques for a two-bus master RFFE system;

FIG. 8 is a signal-time diagram of a bus hand-off technique highlighting suspension of counter incrementing during data transmission; and

FIG. 9 illustrates a simplified block diagram of an exemplary comparator such as could be used by a master of FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include bus ownership hand-off techniques. In particular, bus ownership hand-off is handled by providing a mod-N counter in each master associated with the bus. A single clock source is used to increment each mod-N counter synchronously. Each master also includes a trigger table with N entries, corresponding to the N of the mod-N counter. A master host populates entries in each trigger table according to respective priorities of the masters. A comparator in each master is used to compare entries in the trigger table to the mod-N counter. If there is a match between a populated entry and the mod-N counter, transmission by the master is enabled. If there is not a match, transmission for that master is precluded. By enabling hand-off without negotiation, latency associated with hand-off is reduced to approximately two clock cycles, allowing the device to meet stringent timing requirements for various cellular protocols.

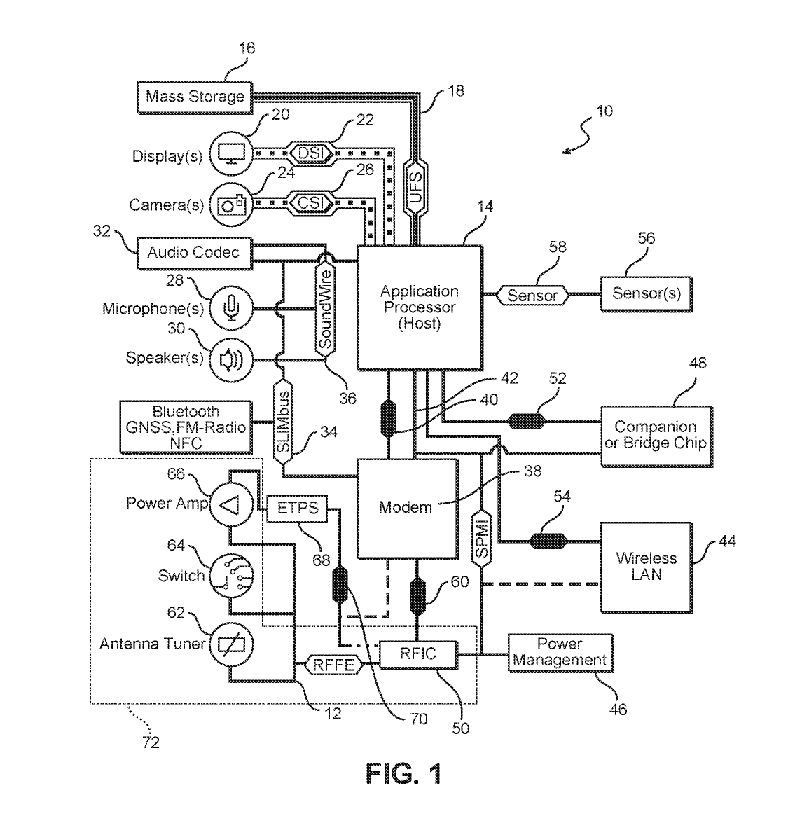

In this regard, FIG. 1 is system-level block diagram of a mobile terminal 10 such as a smart phone, mobile computing device tablet, or the like. While a mobile terminal is particularly contemplated as being capable of benefiting from exemplary aspects of the present disclosure, it should be appreciated that the present disclosure is not so limited and may be useful in any system having a bus that has multiple masters and needing efficient bus ownership hand-off techniques with minimal latency. For the sake of illustration, it is assumed that a radio frequency front-end control interface (RFFE) bus 12 within the mobile terminal 10 implements exemplary bus ownership transfer techniques according to the present disclosure.

With continued reference to FIG. 1, the mobile terminal 10 includes an application processor 14 (sometimes referred to as a host) that communicates with mass storage element 16 through a universal flash storage (UFS) bus 18. The application processor 14 may further be connected to a display 20 through a display serial interface (DSI) bus 22 and a camera 24 through a camera serial interface (CSI) bus 26. Various audio elements such as a microphone 28, a speaker 30, and an audio codec 32 may be coupled to the application processor 14 through a serial low-power interchip multimedia bus (SLIMbus) 34. Additionally, the audio elements may communicate with each other through a SOUNDWIRE™ bus 36. A modem 38 may also be coupled to the SLIMbus 34. The modem 38 may further be connected to the application processor 14 through a peripheral component interconnect (PCI) or PCI express (PCIe) bus 40 and/or a system power management interface (SPMI) bus 42.

With continued reference to FIG. 1, the SPMI bus 42 may also be coupled to a wireless local area network (LAN) integrated circuit 44, a power management integrated circuit (PMIC) 46, a companion integrated circuit (sometimes referred to as a bridge chip) 48, and a radio frequency integrated circuit (RFIC) 50. If should be appreciated that separate PCI buses 52 and 54 may also couple the application processor 14 to the companion integrated circuit 48 and the wireless LAN integrated circuit 44. The application processor 14 may further be connected to sensors 56 through a sensor bus 58. The modem 38 and the RFIC 50 may communicate using a bus 60.

With continued reference to FIG. 1, and of particular interest for the present disclosure, the RFIC 50 may couple to one or more RFFE elements, such as an antenna tuner 62, a switch 64, and a power amplifier 66 through the RFFE bus 12. Additionally, the RFIC 50 may couple to an envelope tracking power supply (ETPS) 68 through a bus 70, and the ETPS 68 may communicate with the power amplifier 66. Collectively, the one or more RFFE elements, including the RFIC 50, may be considered an RFFE system 72.

In exemplary aspects of the present disclosure, multiple masters may be associated with the RFFE bus 12. Under a traditional RFFE protocol, the multiple masters transfer ownership of the RFFE bus 12 through a contention-based protocol, which introduces variable and unacceptable latency in communication over the RFFE bus 12.

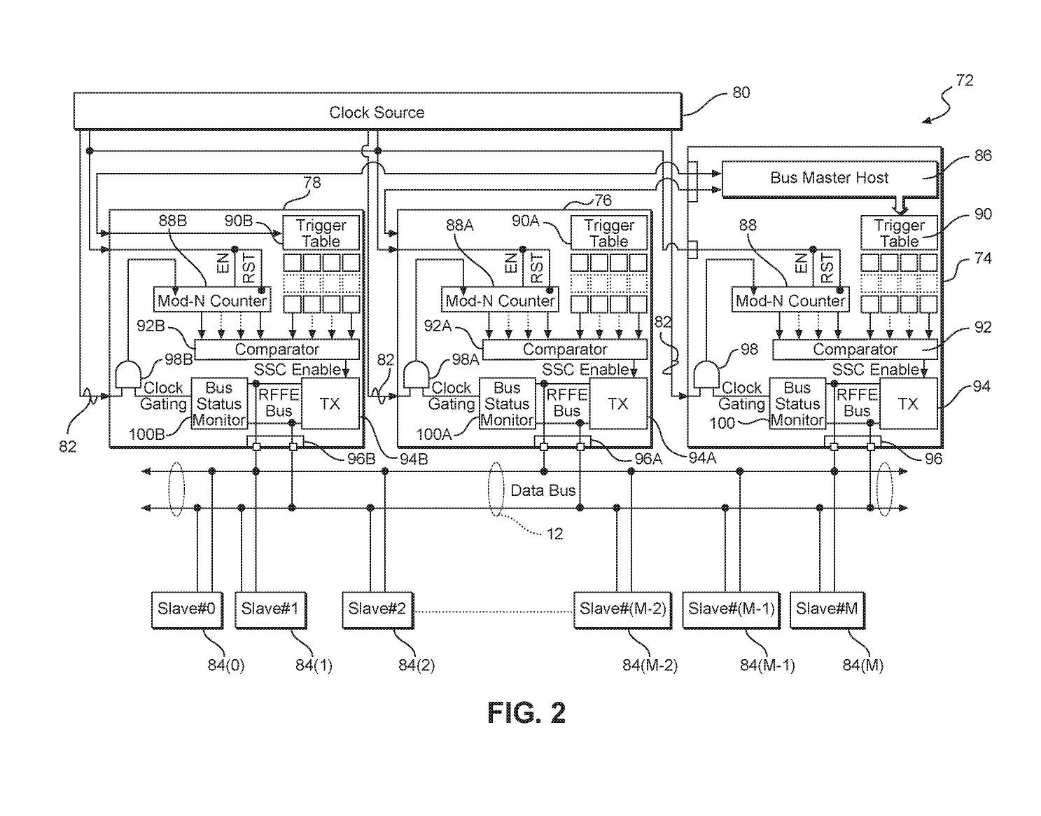

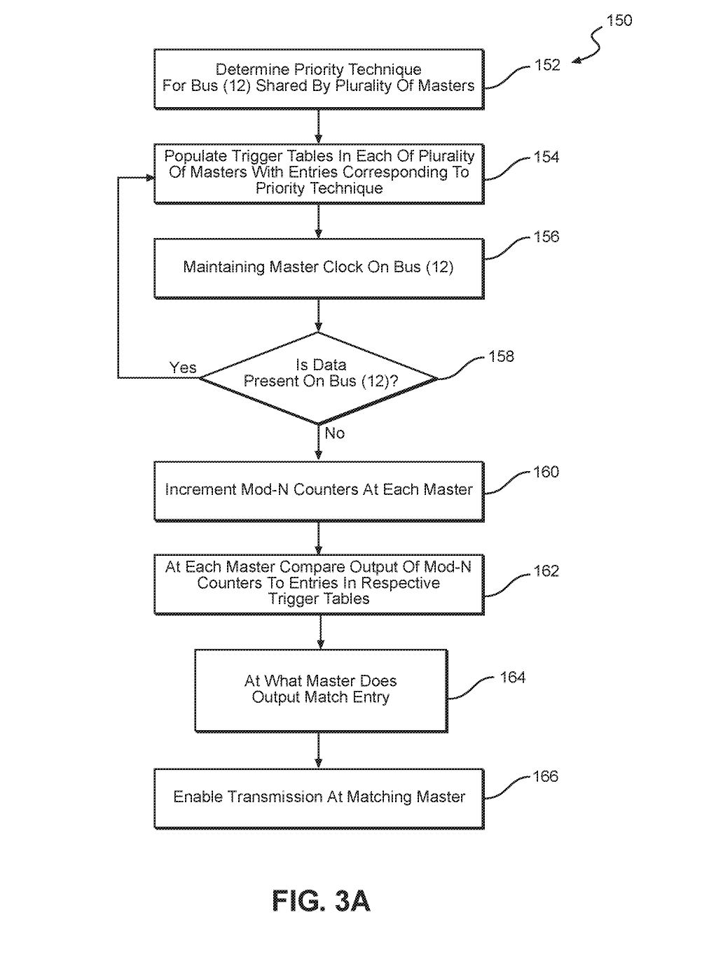

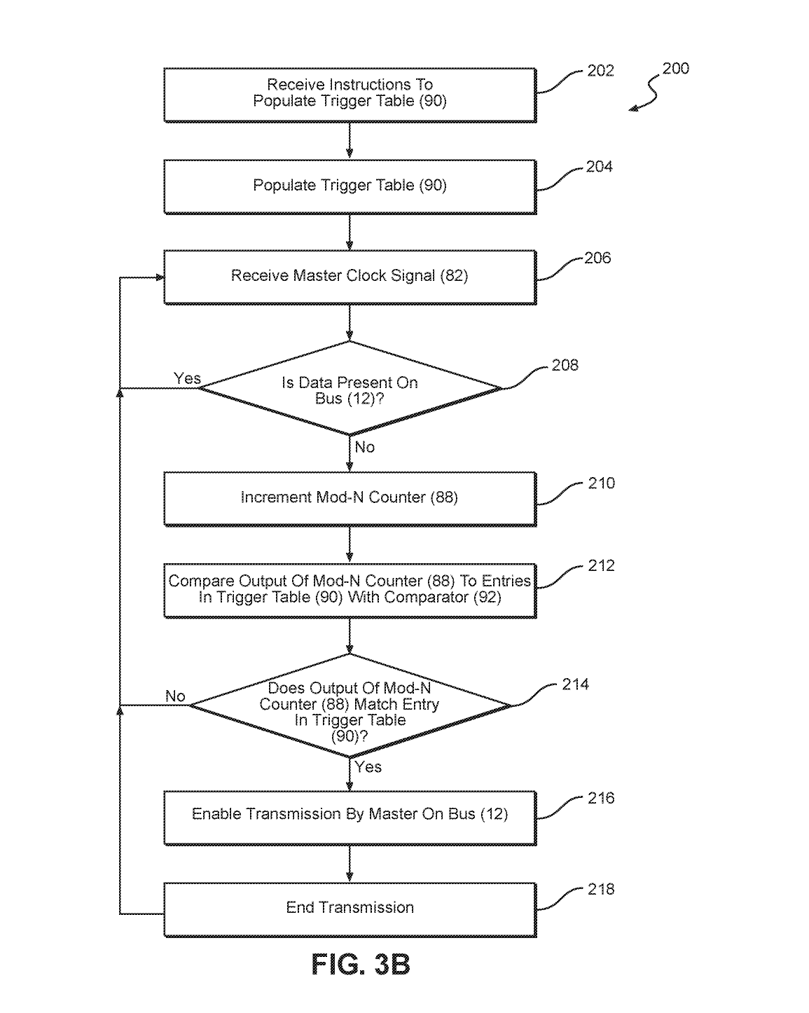

Exemplary aspects of the present disclosure reduce latency from bus ownership transfers between plural masters by eliminating contention-based hand-off and substituting a priority-based technique. Exemplary changes to the plural masters and the process are explicated with reference to FIGS. 2, 3A, and 3B.

In this regard, FIG. 2 illustrates a more detailed view of the RFFE system 72 of FIG. 1. In an exemplary aspect of the present disclosure, a first master 74, a second master 76, and a third master 78 are associated with the RFFE bus 12. As is set forth in the RFFE protocol, the RFFE bus 12 is a two-wire bus, one wire carrying a clock signal and one wire carrying a data signal. While only three masters are illustrated in the RFFE system 72, it should be appreciated that more or fewer masters may be present. A clock source 80 provides a synchronous clock signal 82 to each of the first master 74, the second master 76, and the third master 78. The clock signal 82 may serve as the clock signal on the RFFE bus 12 as well. A plurality of slaves 84(0)-84(M) are likewise associated with the RFFE bus 12. The clock source 80 may further provide a VIO signal (not illustrated) which may power a device. Likewise, the clock source 80 may provide an enable (EN) signal which enables the device.

With continued reference to FIG. 2, the first master 74 includes a bus master host 86. Further, the first master 74 includes a mod-N counter 88, a trigger table 90 with N entries therein (sometimes referred to as enable values), a comparator 92, and a transmitter 94 (sometimes referred to as an RFFE IP block). The transmitter 94 is coupled to the RFFE bus 12 through a bus interface 96. The bus master host 86 determines a relative priority for bus access for the masters 74, 76, and 78 and allows for a fractional priority technique according to exemplary aspects of the present disclosure. In particular, the bus master host 86 populates entries within the trigger table 90. The comparator 92 compares entries in the trigger table 90 to an output from the mod-N counter 88. If there is a match between a populated entry and the mod-N counter 88, the comparator 92 enables transmission by the transmitter 94.

With continued reference to FIG. 2, the mod-N counter 88 increments based on the clock signal 82. In particular, the clock signal 82 arrives at the first master 74 and is passed to a gate 98, which may be an AND gate. The gate 98 also is coupled to a bus status monitor 100. When the bus status monitor 100 detects activity on the RFFE bus 12, a zero is provided to the gate 98. If no activity is detected on the RFFE bus 12, a one is provided to the gate 98. In this manner, the gate 98 selectively increments the mod-N counter 88 only when no data is present on the RFFE bus 12. Otherwise, incrementing of the mod-N counter 88 is suspended until such time as there is no data on the RFFE bus 12.

With continued reference to FIG. 2, the second master 76 also includes a mod-N counter 88A, a trigger table 90A with N entries therein, a comparator 92A, a transmitter 94A, a bus interface 96A, a gate 98A, and a bus status monitor 100A. These elements are substantially similar to the comparably named elements within the first master 74 although, instead of direct population of the trigger table 90, the trigger table 90A is populated by the remote bus master host 86. Similarly, the third master 78 also includes a mod-N counter 88B, a trigger table 90B with N entries therein, a comparator 92B, a transmitter 94B, a bus interface 96B, a gate 98B, and a bus status monitor 100B. These elements are substantially similar to the comparably named elements within the first master 74 although, instead of direct population of the trigger table 90, the trigger table 90B is populated by the remote bus master host 86.

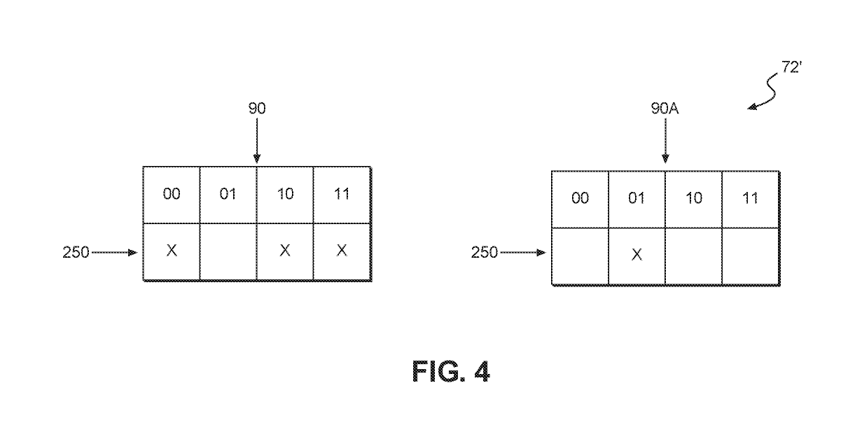

Against the hardware diagrams of FIGS. 1 and 2, exemplary processes associated with the present disclosure are provided with reference to FIGS. 3A and 3B. In this regard, FIG. 3A illustrates a process 150 that looks at the methodology from a system-level perspective. Thus, the process 150 begins by determining a priority technique for a bus (e.g., the RFFE bus 12) shared by a plurality of masters (e.g., the masters 74, 76, and 78) (block 152). As better illustrated below with reference to FIGS. 4-8, the priority technique may be an even priority technique where each master shares time on the bus equally, or an uneven priority technique where the masters share time on the bus according to some predefined ratio (e.g., 60/20/10/10 for four masters, 30/30/30/10 for four masters, 70/20/10 for three masters, 60/40 for two masters, 70/30 for two masters, etc.). Further, the sequence and degree of interleaving of master control on the bus is determined as part of the priority technique. Again, exemplary priority techniques are better illustrated with reference to FIGS. 4-8, discussed below. In an exemplary aspect, the bus master host 86 determines the priority technique. Alternatively, a control system such as the application processor 14 of FIG. 1 may determine the priority technique and provide the priority technique to the bus master host 86.

With continued reference to FIG. 3A, the bus master host 86 then populates trigger tables (e.g., the trigger tables 90, 90A, and 90B) in each of the plurality of masters with entries corresponding to the priority technique (block 154). The RFFE system 72 maintains a master clock on the RFFE bus 12 (block 156). Each master determines if data is present on the RFFE bus 12 (block 158) through the use of a respective bus status monitor (e.g., the bus status monitors 100, 100A, and 100B). If data is present on the RFFE bus 12, then the process 150 returns to maintaining the master clock on the RFFE bus 12 and monitoring the RFFE bus 12 for the presence or absence of data.

With continued reference to FIG. 3A, if there is no data on the RFFE, bus 12, then each AND gate (e.g., the gates 98, 98A, and 98B) allows the clock signal to reach each mod-N counter (e.g., the mod-N counters 88, 88A, and 88B) and the clock signal 82 increments the mod-N counters at each master (block 160). At each master, respective comparators compare outputs of the mod-N counters to entries in the respective trigger tables (block 164), and if there is a match output a transmission enable signal. Thus, the RFFE system 72 effectively determines at what master does output match entry (block 164), and transmission is enabled at the matching master (block 166).

It should be appreciated that by evaluating whether there is data on the RFFE bus 12 prior to incrementing the mod-N counter, the process 150 effectively suspends or precludes incrementing the mod-N counter if data is present. Thus, there will not be collisions on the RFFE bus 12 as multiple masters try to control the RFFE bus 12.

Also note that exemplary aspects of the present disclosure allow for dynamic changes to the priority technique. Thus, for example, the bus master host 86 may send revised instructions on the population of the respective trigger tables as needed or after an event such as a system reset.

FIG. 3B illustrates process 200, which is similar to the process 150 of FIG. 3A, but from a master-level perspective. In this regard, the process 200 begins when the master receives instructions to populate the trigger table 90 (block 202). The instructions may come from a remote bus master host 86 or from a local bus master host 86. Based on the instructions, the master populates the trigger table 90 (block 204). The master receives the master clock signal 82 (block 206) and uses the bus status monitor 100 to determine if data is present on the RFFE bus 12 (block 208). If data is present on the RFFE bus 12, the process 200 returns to receiving the master clock signal 82 at block 206. If, however, no data is present on the RFFE bus 12, then the bus status monitor 100 outputs a one, and the AND gate 98 outputs the clock signal 82 to the mod-N counter 88 so that the mod-N counter 88 may increment (block 210).

With continued reference to FIG. 3B, the master uses the comparator 92 to compare the output of the mod-N counter 88 to entries in the trigger table 90 (block 212) and determines if the output of the mod-N counter 88 matches an entry in the trigger table 90 (block 214). If the answer to block 214 is no, the process 200 returns to block 206 (i.e., receiving the master clock signal 82). If, however, the answer to block 214 is yes, the output of the mod-N counter 88 matches an entry in the trigger table 90, then the comparator 92 enables transmission by the master on the RFFE bus 12 (block 216). Once the transmission ends (block 218), the process 200 returns to the master receiving the master clock signal 82 (block 206).

Again, note that while not illustrated, the master may receive instructions to update entries in the trigger table 90, such as after a system reset or other event. Such instructions may come from the bus master host 86 in the same format as the original table population instructions.

As alluded to above, use of the trigger table 90 with the comparator 92 and the mod-N counter 88 allows efficient, low-latency hand-off between the masters because there is no contention between masters and messages do not have be exchanged each time a master performs a hand-off. Such reduced latency may allow the systems of the present disclosure to meet the ever more stringent timing requirements of various wireless protocols.

In this regard, FIG. 4 illustrates the trigger tables 90 and 90A associated with a two master system 72′ and having a 75/25 priority ratio. The two master system 72′ assumes that N is four (4), and thus, a number of entries 250 in each of the trigger tables 90 and 90A is also four. Since N is four, the mod-N counter 88 can output a 00, 01, 10, or 11. When the instructions come from the bus master host 86, the entries are populated (denoted for the purposes of illustration as an X) according to the priority technique. Thus, to keep the 75/25 priority ratio, the first trigger table 90 has entries populated for 00, 10, and 11 (i.e., 75% of the entries) and the second trigger table 90A has only one entry populated at 01. Note that which entries are assigned to which master is also a parameter that may be manipulated to achieve desired results. That is, the choice to populate 00 for the first master means that the first master will have the first opportunity to use the RFFE bus 12.

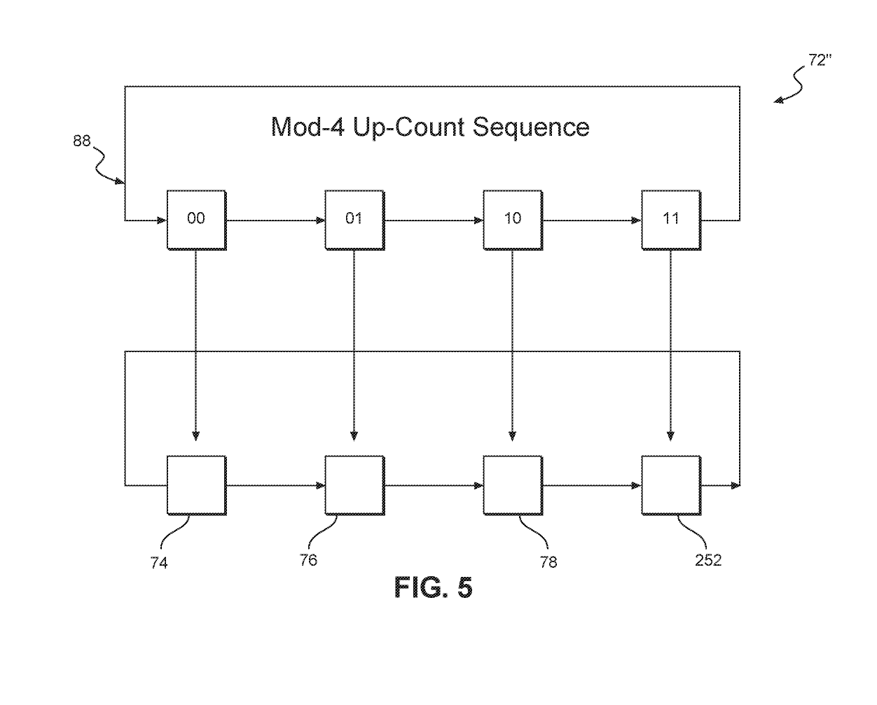

FIG. 5 illustrates a four-bus master system 72″ where each master is allocated equal access to the RFFE bus 12 by the priority technique. Thus, N is again four for simplicity and as the mod-N counter 88 increments, each master 74, 76, 78, and 252 has access to the RFFE bus 12 in turn. The order in which the masters 74, 76, 78, and 252 are provided access to the RFFE bus 12 may be changed to provide one master earlier access, but over the cycle, each master has equal opportunity to use the RFFE bus 12.

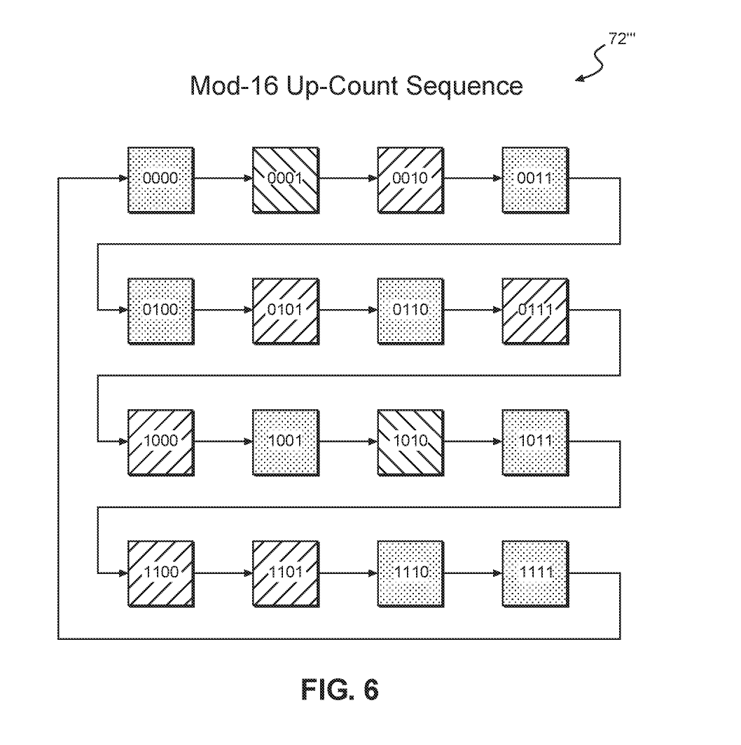

FIG. 6 illustrates a three-bus master system 72′″ where N is sixteen, and the priority ratios are 50/12.5/37.5. That is, the first master 74 may be allocated 0000, 0011, 0100, 0110, 1001, 1011, 1110, and 1111 (denoted by dots), the second master 76 may be allocated 0001 and 1010 (denoted by \), and the third master 78 may be allocated 0010, 0101, 0111, 1000, 1100, and 1101 (denoted by /). As the mod-N counters 88, 88A, and 88B increment, control of the RFFE bus 12 is passed between the different masters 74, 76, and 78 without the need for contention-based messaging or the like. Note that the opportunities that a master has to use the RFFE bus 12 may be sequential (e.g., 1100 and 1101 or 1110 or 1111) or non-sequential (e.g., 0001 and 1010).

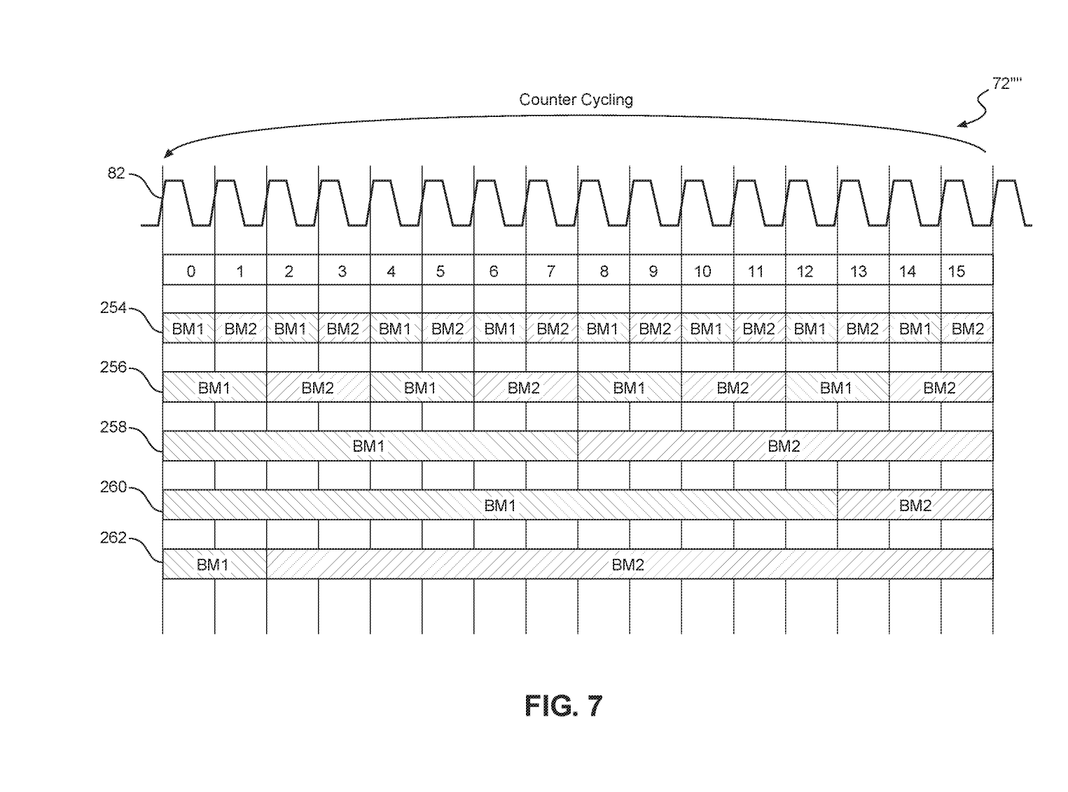

FIG. 7 illustrates a two-bus master system 72″″ where the priority technique is varied along a number of different parameters. The top line is the master clock signal 82 and the second line shows the effective count of the mod-N counter (assuming N is sixteen and expressed in decimal notation instead of binary). The third line 254 assumes each master has equal priority with alternating access. The fourth line 256 assumes each master has equal priority with longer periods assigned to the master each time it has control (i.e., two counts of the mod-N counter). The priority technique of the fourth line 256 allows the masters to have relatively small wait periods to use the RFFE bus 12 while also allowing the masters two counter increments to finish up use of the RFFE bus 12. The fifth line 258 assumes each master has equal priority, but controls the RFFE bus 12 for sequential counter increments. This priority technique gives longer wait times for hand-off of the RFFE bus 12. The sixth line 260 has an 81.25/18.75 ratio with each master having sequential counter increments. The seventh line 262 has a 12.5/87.5 ratio with sequential counter increments.

As should be appreciated, the value of N, the number of masters, the ability to have sequential or non-sequential access to the RFFE bus 12, and the ability to have different ratios, give great flexibility in manipulation of the priority technique to meet particular needs of designers. As noted above, the bus master host 86 may further dynamically change the priority technique as needed or desired in the event circumstances change and a different master needs more access to the RFFE bus 12.

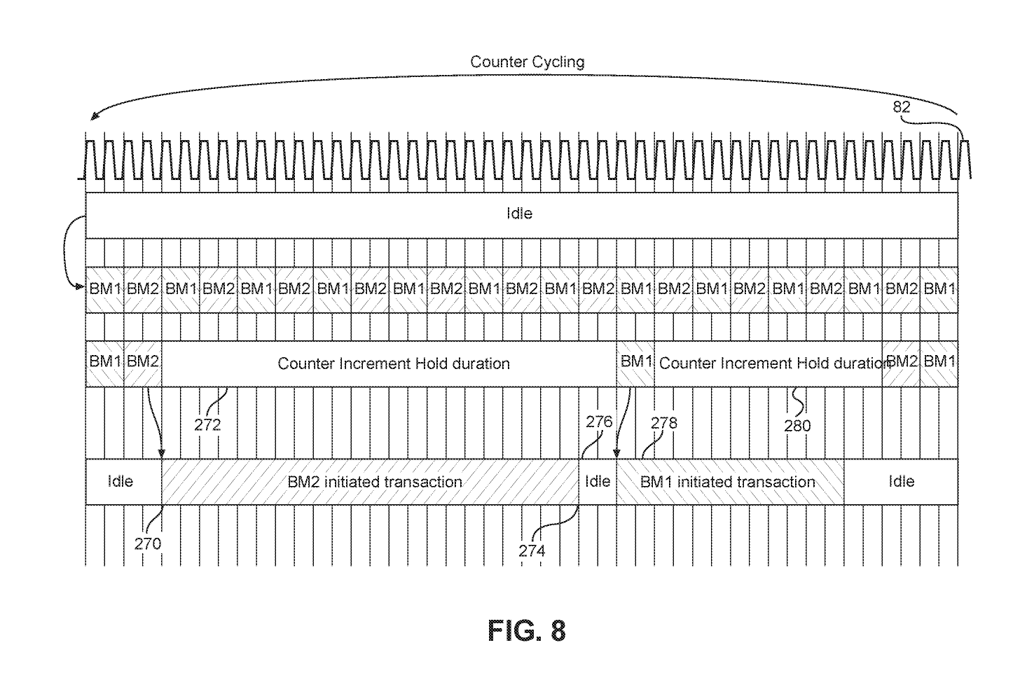

FIG. 8 illustrates how on the start of an active transmission (e.g., when the second master 76 initiates transaction at 270), the counter increment is put on hold (illustrated generally at 272) until the end of the transaction (illustrated generally at 274). The on-going transaction is allowed to complete before an alternate master can have bus ownership. The counter increment is resumed once an idle period (illustrated generally at 276) is detected, and then the next master is allowed to initiate a transaction (illustrated generally at 278). During the next transaction, the counter increment is again placed on hold (illustrated generally at 280). Due to the counter increment being suspended during the active transaction, the bus ownership opportunity automatically goes to the next bus master waiting in priority sequence.

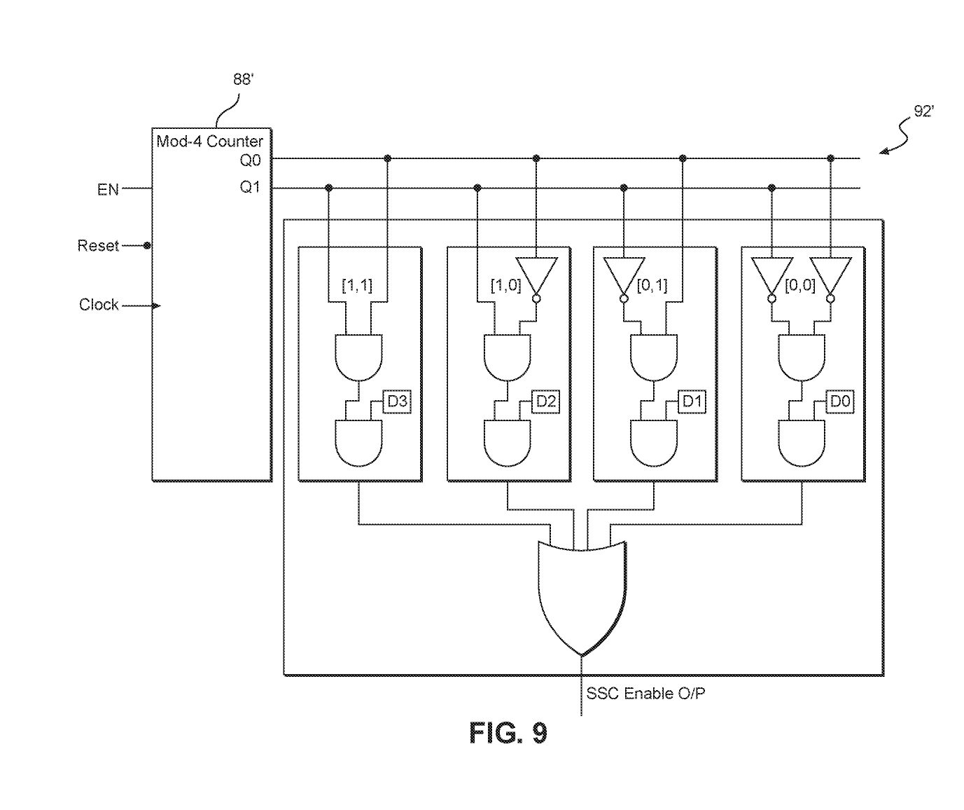

FIG. 9 illustrates an exemplary comparator 92′ with mod-4 counter 88′. It should be appreciated that while a particular combination of AND and OR gates are illustrated, other hardware arrangements may also be used. However, by keeping the number of gates to a relative minimum, the delay between bus hand-off is approximately two clock cycles, ensuring relatively low latency.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for controlling a bus shared by plural masters, the method comprising:
incrementing a mod-N counter at a first master of a plurality of master devices, the incrementing based on a clock signal;
comparing an output of the mod-N counter to a trigger table; and
enabling transmission by the first master on an associated bus if the output of the mod-N counter matches an entry in the trigger table.

2. The method of claim 1, wherein enabling the transmission on the associated bus comprises enabling the transmission on an associated radio frequency front-end control interface (RFFE) bus.

3. The method of claim 1, further comprising receiving instructions to populate the trigger table.

4. The method of claim 3, wherein receiving the instructions to populate the trigger table comprises receiving the instructions from a bus master host.

5. The method of claim 3, wherein receiving the instructions to populate the trigger table comprises receiving the instructions which populate selected values corresponding to possible outputs of the mod-N counter.

6. The method of claim 5, wherein the selected values are consecutive.

7. The method of claim 5, wherein the selected values are interspersed evenly throughout all possible values.

8. The method of claim 5, wherein the selected values are interspersed unevenly throughout all possible values.

9. The method of claim 1, further comprising adjusting entries in the trigger table after a first system reset and before a second system reset.

10. The method of claim 1, further comprising receiving a master clock signal common to all of the plurality of master devices, and wherein the incrementing based on the clock signal comprises incrementing based on the master clock signal.

11. The method of claim 1, further comprising precluding use of the associated bus if the output of the mod-N counter fails to match an entry in the trigger table.

12. The method of claim 1, further comprising suspending incrementing the mod_N counter if data is present on the associated bus.

13. A method for controlling a bus shared by plural masters, the method comprising:
determining a priority technique for sharing a bus by a plurality of masters;
populating trigger tables in each of the plurality of masters with entries corresponding to the priority technique;
maintaining a master clock signal on the bus;
at each master of the plurality of masters, incrementing a mod-N counter based on the master clock signal;
at each master of the plurality of masters, comparing an output of the mod-N counter to the entries in a respective one of the trigger tables; and
enabling transmission on the bus by different ones of the plurality of masters based on whether the output of a respective mod-N counter matches an entry in the respective one of the trigger tables.

14. The method of claim 13, further comprising suspending incrementing the mod-N counter if data is present on the bus.

15. The method of claim 13, wherein determining the priority technique comprises determining an access ratio.

16. The method of claim 15, further comprising assigning the entries corresponding to values within the trigger tables based on the access ratio.

17. A master comprising:
a bus interface configured to receive a clock signal from a bus;
a mod-N counter configured to increment based on the clock signal;
a trigger table configured to store enable values;
a comparator coupled to the mod-N counter and the trigger table, the comparator configured to compare an output of the mod-N counter to the enable values in the trigger table and output a transmit enable signal based thereon; and
a transmitter configured to transmit data on the bus when the transmit enable signal is present.

18. The master of claim 17, wherein the trigger table is configured to be populated by a remote master host.

19. The master of claim 17, wherein the trigger table is configured to allow entries to be changed dynamically from a remote master host.

20. The master of claim 17, wherein the trigger table comprises a register.

21. The master of claim 17, wherein the bus interface comprises a radio frequency front-end interface control interface (RFFE).

22. The master of claim 17, wherein the mod-N counter is configured to suspend incrementing when data is present on the bus.

23. The master of claim 22, further comprising a clock gate and a bus status monitor communicatively coupled to the mod-N counter and configured to indicate to the mod-N counter that data is present on the bus.

24. The master of claim 17, wherein the comparator comprises a plurality of AND gates and an OR gate.

25. The master of claim 17, wherein the transmitter is configured to transmit within two clock cycles of completion of a previous data transmission from a different master.

26. The master of claim 17, wherein non-sequential entries of the trigger table are populated.

27. A system comprising:
a bus;
a clock source;
a master host comprising a control system and a bus interface, the bus interface coupled to the bus; and
a plurality of masters, each of the plurality of masters comprising:
the bus interface configured to receive a clock signal from the clock source;
a mod-N counter configured to increment based on the clock signal;
a trigger table configured to store enable values based on input from the master host;
a comparator coupled to the mod-N counter and the trigger table, the comparator configured to compare an output of the mod-N counter to the enable values in the trigger table and output a transmit enable signal based thereon; and
a transmitter configured to transmit data on the bus when the transmit enable signal is present.
